(19) United States
(12) Patent Application Publication
(10) Pub. No.: US 2025/0205114 A1
(43) Pub. Date: Jun. 26, 2025

(54) Bag Intended to Contain Medical Substances for Intravenous Injection

(71) Applicant: TECHNOFLEX, BIDART (FR)

(72) Inventors: Daniel ITHURBIDE, BIARRITZ (FR); Bérénice DEHODANG, BAYONNE (FR); Fabien PRUVOT, SAINT PEE SUR NIVELLE (FR); Isabelle CONSTANT, BRISCOUS (FR); Florent MOUREAUX, BIDART (FR)

(21) Appl. No.: 18/848,316

(22) PCT Filed: Mar. 23, 2023
(86) PCT No.: PCT/FR2023/050417

§ 371 Date: Sep. 18, 2024

(30) Foreign Application Priority Data
Mar. 23, 2022 (FR) FR2202581

(51) Int. Cl. A61J 1/10; A61J 1/20

(52) U.S. Cl. CPC A61J 1/10; A61J 1/2093

(57) ABSTRACT

The invention relates to a bag intended to contain medical substance for intravenous injection (1) comprising:
a first wall (2), and
a second wall (3),
   the first wall (2) and the second wall (3) being assembled together by weld zones (6), the weld zones (6) delimiting at least one first compartment (11) intended to contain a first medical substance and at least one second compartment (12) intended to contain a second medical substance,
   wherein the weld zone (6) include a peelable weld zone (68) separating the first compartment (11) from the second compartment (12), and wherein a ratio I/L between a dimension I of the peelable weld zone (68), and a dimension L measured between a first permanent weld (64) and a second permanent weld (65) along an axis passing through the first compartment (11), is comprised in a range extending from ⅓ to ¾.

### TECHNICAL FIELD

The invention relates to a bag intended to contain medical substances for intravenous injection, a method for preparing a medicinal solution by means of such a bag and a method for manufacturing such a bag.

### BACKGROUND

Bags intended to contain medicinal solutions for intravenous injection (such as a medicine, a solute, a physiological solution or a product derived from blood for example) are flexible bag which can be connected to a tube allowing the parenteral administration of the medicinal solution to a patient or allowing extraction by means of a syringe of the medicinal solution from the bag for the purpose of administering to the patient.

These bags are generally manufactured by welding two flexible films of polymer material together.

These bags can be sterilized by irradiation before aseptic filling and/or by autoclaving after filling.

Document FR 3 058 638 A1 describes a bag for medical use formed from two transparent films, and comprising a first compartment intended to be filled with a first compound in liquid form and a second compartment intended to be filled with a second compound in powder form. The bag for medical use includes a permanent weld on the perimeter of the bag and a peelable weld between the two compartments. The peelable weld is intended to be ruptured at the moment when the bag is used, so as to put the first compartment and the second compartment into communication in order to mix the first compound and the second compound together just prior to administration to the patient.

Such bags allow packaging very unstable medical substances, which cannot be preserved while being mixed, and which necessitate being mixed together in order to reconstitute the medicinal solution just prior to administration to the patient.

One problem of these bags is that the rupture of the peelable weld is not always well controlled.

Yet depending on the place where the rupture of the peelable weld occurs and the extent of the rupture, there exists a risk that the first compound is not mixed within the totality of the volume of the second compartment. In this case, the mixture between the two compounds is not complete, which does not allow the prescribed dosage to be certainly complied with.

In addition, during the administration of the medical substance, there exists a risk that the two films will adhere together, thus creating a retention zone, which prevent the bag from emptying itself totally. In this case, the patient does not receive the totality of the medical substance.

### SUMMARY

One object is to propose a bag intended to contain medical substances for intravenous injection which allows obtaining better control of the mixture between two medical substances.

This object is attained due to a bag intended to contain medical substances for intravenous injection, comprising:
a first wall, and
a second wall,
   the first wall and the second wall being assembled together by weld zones, the weld zones delimiting at least one first compartment intended to contain a first medical substance and at least one second compartment intended to contain a second medical substance,
   wherein the weld zones include:
a first permanent weld zone extending along a first longitudinal edge of the bag,
a second permanent weld zone extending along a second longitudinal edge of the bag, opposite to the first longitudinal edge, and
a third peelable weld zone separating the first compartment from the second compartment,
   wherein the third peelable weld zone extends from the first permanent weld zone to the second permanent weld zone, so as to form a first junction between the third peelable weld zone and the first permanent weld zone, and a second junction between the third peelable weld zone and the second permanent weld zone,
   and wherein a ratio I/L between a dimension I of the third peelable weld zone measured between the first junction and the second junction along a transverse axis, and a dimension L measured between the first permanent weld and the second permanent weld along an axis parallel to the transverse axis and passing through the first compartment, is comprised in a range extending from ⅓ to ¾.

The specific dimension ratio between the third peelable weld zone and the spacing between the two permanent weld zones allows controlling the location where the rupture occurs as well as the extent of the rupture, in a repeatable manner.

In fact, it has been observed that a ratio I/L of less than ⅓ has the effect that the third peelable weld zone is difficult to break. In this case, the extent of the rupture of the third peelable weld zone can be insufficient, which does not allow generating a sufficient flow rate of the first medical substance, which penetrates into the second compartment, to guarantee a complete and homogeneous mixture with the second medical substance.

A ratio I/L greater than ¾ has the effect that the stress exerted on the third peelable weld zone is not homogeneously distributed along the third peelable weld zone. In this case, it is not possible to accurately control the location where the rupture of the third peelable weld zone occurs, which does not allow favorably locating the flow of the first medical substance which penetrates into the second compartment to guarantee a full and homogeneous mixture with the second medical substance.

On the other hand, with a ratio I/L comprised in the range extending from ⅓ to ¾, as proposed, it is possible to control both the orientation and the intensity of the flow of the first medical substance which penetrates into the second compartment, without having to exert excessive pressure on the first compartment. This allows obtaining a complete and homogeneous mixture of the two substances, in a repeatable manner.

The bag can also have the following features:
the ratio I/L is comprised in a range extending from ⅓ to ⅔.
the first permanent weld zone comprises a first longitudinal portion extending parallel to the first longitudinal edge of the bag and a first flaring portion extending from the first longitudinal portion to the first junction, the first flaring portion delimiting the first compartment by forming a first angle comprised in a range extending from 0° to +70° with a transverse axis extending perpendicular to the longitudinal edges, and the second permanent weld zone comprises a second longitudinal portion extending parallel to the second longitudinal edge of the bag and a second flaring portion extending from the second longitudinal portion to the second junction, the second flaring portion delimiting the first compartment by forming a second angle comprised in a range extending from −70° to 0 with the transverse axis.
the first angle is comprised in a range extending from 0° to +50° relative to the transverse axis, and the second angle is comprised in a range extending from −50° to 0° with the transverse axis.
the first angle is comprised in a range extending from +20° to +50° relative to the transverse axis, and the second angle is comprised in a range extending from −50° to −20° with the transverse axis.
the first permanent weld zone comprises a third longitudinal portion extending parallel to the first longitudinal edge of the bag and a third flaring portion extending from the third longitudinal portion to the first junction, the third flaring portion delimiting the second compartment and forming a third angle comprised in a range extending from −70° to 0 with a transverse axis extending perpendicular to the longitudinal edges, and the second permanent weld zone comprises a fourth longitudinal portion extending parallel to the second longitudinal edge of the bag and a fourth flaring portion extending from the fourth longitudinal portion to the second junction, the fourth flaring portion delimiting the second compartment by forming a fourth angle comprised in a range extending from 0° to +70° with the transverse axis.
the third angle is comprised in a range extending from −50° to 0 relative to the transverse axis, and the fourth angle is comprised in a range extending from 0° to +50° with the transverse axis.
the third angle is comprised in a range extending from −50° to −20° relative to the transverse axis, and the fourth angle is comprised in a range extending from +20° to +50° with the transverse axis.
the first permanent weld zone and the second permanent weld zone has been obtained by fusion of the first wall and of the second wall at a first temperature, and the third peelable weld zone has been obtained by fusion of the first wall and of the second wall at a second temperature, lower than the first temperature, so that when the first medical substance is received in the first compartment and a pressure is exerted on the first compartment, the pressure exerted on the first compartment causes a rupture of the third peelable weld zone, thus allowing penetration of the first medical substance into the second compartment.
the bag comprises the first medical substance contained in the first compartment.
the first medical substance is a liquid substance.
the bag comprises the second medical substance contained in the second compartment.
the second medical substance is a powder or a lyophilisate.

A medicinal solution can be prepared by means of a method for preparing a medicinal solution using a bag as previously defined, wherein the first compartment of the bag contains a first medical substance and the second compartment of the bag contains a second medical substance, the method comprising a step of pressing the first compartment so as to cause a rupture of the third peelable weld zone, thus allowing penetration of the first medial substance into the second compartment.

A bag as previously defined can be manufactured according to a manufacturing method, comprising steps of:
welding together a first wall and a second wall at weld zones, the weld zones delimiting at least one first compartment intended to receive a first medical substance and at least one second compartment intended to receive a second medical substance, and
   in which the weld zones include:
a first permanent weld zone extending along a first longitudinal edge of the bag,
a second permanent weld zone extending along a second longitudinal edge of the bag, opposite to the first longitudinal edge, and
a third peelable weld zone separating the first compartment from the second compartment,
   wherein the third peelable weld zone extends from the first permanent weld zone to the second permanent weld zone, so as to form a first junction between the third peelable weld zone and the first permanent weld zone, and a second junction between the third peelable weld zone and the second permanent weld zone,
   and wherein a ratio I/L between a dimension I of the third peelable weld zone measured between the first junction and the second junction, and a dimension L of the first compartment measured between the first permanent weld and the second permanent weld, is comprised in a range extending from ⅓ to ¾.

The steps of welding together the first wall and the second wall can comprise:
welding the first wall and the second wall at the first permanent weld zone and at the second permanent weld zone, by fusion of the first wall and of the second wall at a first temperature, and
welding together the first wall and the second wall at the third peelable weld zone, by fusion of the first wall and of the second wall at a second temperature, lower than the first temperature.

### PRESENTATION OF THE DRAWINGS

Other features and advantages will still be revealed by the description that follows, which is purely illustrative and not limiting, and must be read with reference to the appended figures, among which:

FIG. 1 shows schematically a bag intended to contain medical substances for intravenous injection, in front view,

FIG. 2 shows the bag of FIG. 1, in rear view,

FIG. 3 shows schematically a bag intended to contain medical substances for intravenous injection according to a first possible embodiment, prior to filling,

FIG. 4 shows schematically a bag intended to contain medical substances for intravenous injection according to a second possible embodiment, prior to filling,

FIG. 5 shows schematically a step of preparing a medicinal solution using a bag,

FIG. 6 shows schematically a bag intended to contain medical substances for intravenous injection according to a third possible embodiment, prior to filling,

FIG. 7 shows schematically a bag intended to contain medical substances for intravenous injection according to a fourth possible embodiment, prior to filling.

### DETAILED DESCRIPTION OF AN EMBODIMENT

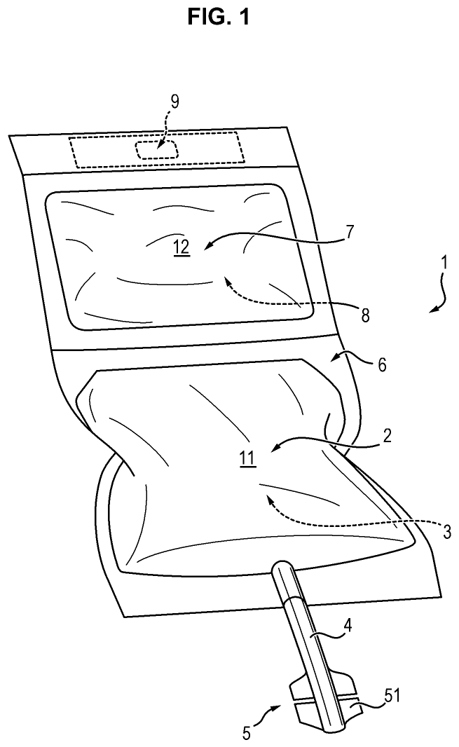

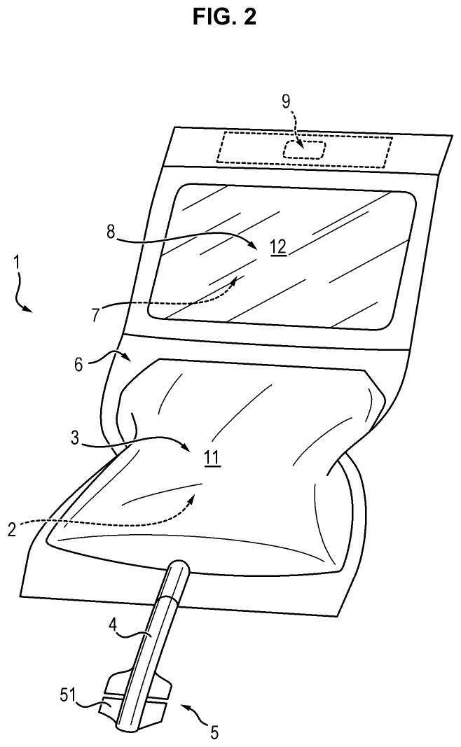

On FIGS. 1 and 2, the bag 1 shown comprises a first wall 2, a second wall 3, a filling tube 4 and a connector 5.

The first wall 2 and the second wall 3 are assembled together by thermal welding at a plurality of weld zones 6. The weld zones 6 delimit, between the first wall 2 and the second wall 3, a first compartment 11 and a second compartment 12, separated from the first compartment 11.

The first compartment 11 contains a first medical substance and the second compartment 12 contains a second medical substance.

In the example illustrated in FIG. 1, the first medical substance is a liquid substance and the second medical substance is a substance in powder form or a lyophilisate. The powder substance or the lyophilisate contains for example an active ingredient (such as an antibiotic, an anticancer drug, an antifungal or a blood derivative) and the liquid substance is for example a diluent, suitable for diluting the powder substance or the lyophilisate. The liquid substance and the powder substance (or the lyophilisate) are intended to be mixed together in order to prepare a medicinal solution, just prior to the administration of the medicinal solution to a patient.

The first wall 2 can be formed from a first film of polymer material, for example a polymer material comprising a polyolefin, such as polypropylene or polyethylene.

Likewise, the second wall 3 can be formed of a second film identical to the first film. The second wall can be formed of a second film of polymer material, for example of polymer material comprising a polyolefin, such as polypropylene or polyethylene.

The filling tube 4 is arranged between the first wall 2 and the second wall 3, so as to allow filling of the first compartment 11 with the first medical substance via the filling tube 4. More precisely, the filling tube 4 has a first end having a first opening leading into the first compartment 11, and a second end, opposite to the first end, having a second opening leading to the outside of the first compartment 11. More precisely, the second opening leads to the outside of the bag 1. The filling tube 4 also comprises an internal channel extending from the first opening to the second opening.

The connector 5 closes in a sealed manner the second opening of the filling tube 4. The connector 5 comprises a severable portion 51 which can be ruptured. Once ruptured, the severable portion 51 can be detached from the rest of the connector 5 and a needle can be inserted into the connector 5, for example in order to connect the filling tube 4 of the bag 1 to an intravenous perfusion device or to a syringe.

Moreover, as illustrated in FIG. 1, the bag 1 can also comprise a first protection sheet 7 attached to the first wall 2 and/or a second protection sheet 8 attached to the second wall 3.

The first protection sheet 7 covers an outer surface of the first wall 2 so as to mask the second compartment 12, but without masking the first compartment 11. Likewise, the second protection sheet 8 covers an outer surface of the second wall 3, so as to mask the second compartment 12, but without masking the first compartment 11.

The first protection sheet 7 and the second protection sheet 8 each form a barrier which prevents penetration of humidity, of light rays and/or of oxygen respectively through the first wall 2 and through the second wall 3, into the interior of the second compartment 12 which contains the second medical substance.

To this end, the first protection sheet 7 and the second protection sheet 8 can each comprise a layer of aluminum, or a layer of a composite containing aluminum.

The first protection sheet 7 and/or the second protection sheet 8 can be attached respectively to the first wall 2 and/or to the second wall 3 by a peelable weld, allowing withdrawing the first protection sheet 7 and/or the second protection sheet 8 prior to the use of the bag. The withdrawal of the first protection sheet 7 and/or of the second protection sheet 8 can allow visually checking the condition of the second medical substance contained in the second compartment 12, before proceeding with mixing the first medical substance with the second medical substance.

Alternatively, the first protection sheet 7 and/or the second protection sheet 8 can be attached respectively to the first wall 2 and/or to the second wall 3 by a permanent weld. In this case, the first protection sheet 7 and/or second protection sheet 8 are not withdrawn prior to the use of the bag. The first protection sheet 7 and/or the second protection sheet 8 can be transparent to light rays in the visible range, in order to allow visually checking the condition of the second medical substance contained in the second compartment 12.

The bag 1 can also have an aperture 9 provided through both the first wall 2 and the second wall 3 in a weld zone, the aperture 9 allowing suspending the bag 1 by a hook during its use.

When the bag 1 is suspended by a hook, the second compartment 12 is arranged above the first compartment 11, and the filling tube 4 extends vertically downward.

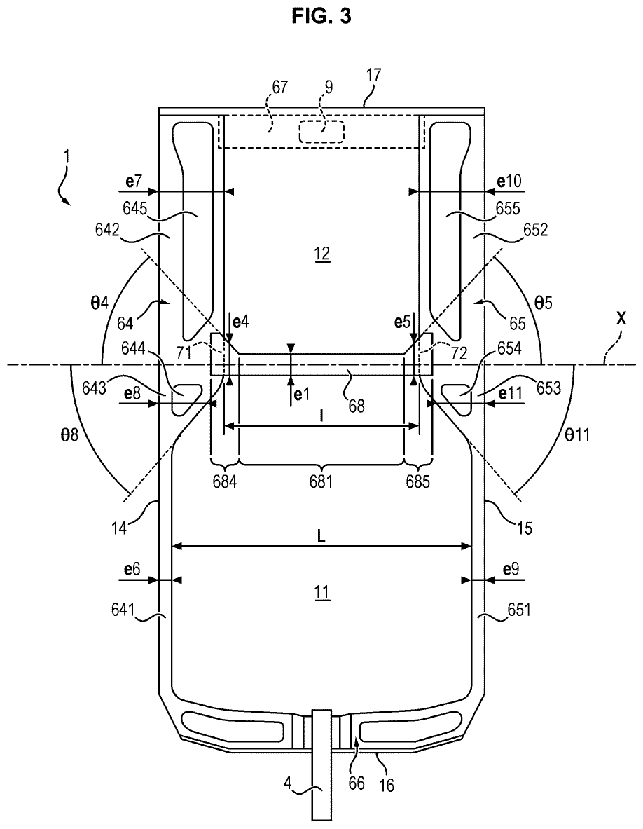

FIG. 3 shows schematically a bag 1 according to a first embodiment.

By way of example, the bag 1 illustrated in FIG. 3 can be dimensioned so that the first compartment 11 is suitable for containing approximately 250 milliliters of the first medical substance in liquid form, while the second compartment 12 is suitable for containing from a few milligrams to several hundred grams of the second medical substance in the powder form, for example 100 grams.

The bag 1 illustrated in FIG. 3 comprises a first longitudinal edge 14, a second longitudinal edge 15, opposite to the first longitudinal edge 14, a first transverse edge 16 and a second transverse edge 17, opposite to the first transverse edge 16.

The bag 1 also comprises a plurality of weld zones 6 delimiting the first compartment 11 and the second compartment 12.

More precisely, the weld zones 6 include a first longitudinal weld zone 64 extending along the first longitudinal edge 14 and a second longitudinal weld zone 65 extending along the second longitudinal edge 15.

In addition, the weld zones 6 also include a first transverse weld zone 66 extending along the first transverse edge 16.

In FIG. 3, the bag 1 is shown prior to filling. That is to say that the first compartment 11 does not yet contain the first medical substance and the second compartment does not yet contain the second medical substance. That is why the weld zones 6 do not yet include a second transverse weld zone extending along the second transverse edge 17. Thus, the second medical substance can be introduced into the second compartment 12 via the opening which subsists between the first wall 2 and the second wall 3 which are not welded together along the second transverse edge 17.

However, once the second compartment 12 has been filled with the second medical substance, a second transverse weld zone 67 extending along the second transverse edge 17 can be made (the second transverse weld zone 67 is illustrated in dotted lines in FIG. 3).

In addition, an aperture 9 can be provided in the second transverse weld zone 67, through both the first wall 2 and the second wall 3, to allow suspending the bag 1 from a hook.

The first longitudinal weld zone 64, the second longitudinal weld zone 65, the first transverse weld zone 66 and the second transverse weld zone 67 are permanent weld zones. That is to say that these weld zones were obtained by subjecting the first wall 2 and the second wall 3 to a first temperature having caused the fusion of the first film and of the second film together, so as to obtain a permanent bond of the walls 2 and 3 together in these weld zones. The selection of the first temperature depends on the composition of the first film and of the second film. The first temperature can for example be comprised between 90 and 160 degrees Celsius. In the case of polypropylene films, the first temperature can be on the order of approximately 140 to 150 degrees Celsius for 3 seconds.

Moreover, the weld zones 6 also include a separating weld zone 68 which separates the first compartment 11 from the second compartment 12. That is to say that the separating weld zone 68 extends between the first compartment 11 and the second compartment 12, prevents penetration of the first substance contained in the first compartment 11 into the second compartment, and prevents penetration of the second substance contained in the second compartment 12 into the first compartment 11.

Thus, the first compartment 11 is delimited by the first longitudinal weld zone 64, the second longitudinal weld zone 65, the first transverse weld zone 66 and the separating weld zone 68.

The second compartment 12 is delimited by the first longitudinal weld zone 64, the second longitudinal weld zone 65, the separating weld zone 68 and the second transverse weld zone 67.

The separating weld zone 68 is a peelable weld zone. That is to say that this zone was produced by submitting the first wall 2 and the second wall 3 to a second temperature having caused fusion of the first film and of the second film, the second temperature being lower than the first temperature.

In this manner, the first wall 2 and the second wall 3 are assembled together at the separating weld zone 68, but the assembly obtained is not permanent. Thus, during the use of the bag 1, the weld can be ruptured in this zone, for example under the influence of a pressure exerted on the first compartment 11.

The selection of the second temperature depends on the composition of the first film and of the second film. The second temperature can for example be comprised between 65 and 145 degrees Celsius.

As illustrated in FIG. 3, the separating weld zone 68 extends from the first longitudinal weld zone 64 to the second longitudinal weld zone 65.

In addition, the separating weld zone 68 extends in a transverse direction along a transverse axis X of the bag 1. The transverse axis X extends between the first compartment 11 and the second compartment 12. The first compartment 11 is located on a first side of the transverse axis X and the second compartment 12 is located on a second side of the transverse axis X, opposite to the first side.

The separating weld zone 68 extends from the first longitudinal weld zone 64 to the second longitudinal weld zone 65, so as to form a first junction 71 between the separating weld zone 68 and the first longitudinal weld zone 64, and a second junction 72 between the separating weld zone 68 and the second longitudinal weld zone 65.

In other words, the first junction 71 is the location where the separating weld zone 68 encounters the first longitudinal weld zone 64, and the second junction 72 is the place where the separating weld zone 68 encounters the second longitudinal weld zone 65.

The separating weld zone 68 has a dimension I measured between the first junction 71 and the second junction 72, parallel to the transverse axis X.

Moreover, the first compartment 11 has a dimension L measured between the first longitudinal weld 64 and the second longitudinal weld 65, parallel to the transverse axis X.

The dimension L corresponds to the maximum spacing between the first longitudinal weld 64 and the second longitudinal weld 65 measured along an axis passing through the first compartment 11, parallel to the transverse axis X.

The ratio I/L is comprised in a range extending from ⅓ to ¾, preferably in a range extending from ⅓ to ⅔.

More precisely, in the example illustrated in FIG. 3, the ratio I/L is equal to 0.65.

In the example illustrated in FIG. 3, the separating weld zone 68 comprises a central portion 681, a first lateral portion 684 and a second lateral portion 685. The two lateral portions 684 and 685 extend on either side of the central portion 681. The first lateral portion 684 extends from the central portion 681 to the first longitudinal weld zone 64. The second lateral portion 685 extends from the central portion 681 to the second longitudinal weld zone 65.

In the example illustrated in FIG. 3, the central portion 681 is rectilinear and extends parallel to the transverse axis X of the bag 1, in other words, the central portion 681 has two edges parallel to the transverse axis X.

The central portion 681 of the separating weld zone 68 has a thickness e1 less than a thickness e4, e5 of each of the lateral portions 684, 685 of the separating weld zone 68.

More precisely, in the example illustrated in FIG. 3, the central portion 681 of the separating weld zone 68 has a constant thickness e1.

The first lateral portion 684 of the separating weld zone 68 flares from the central portion 681 to the first longitudinal weld zone 64.

Likewise, the second lateral portion 685 of the separating weld zone 68 flares from the central portion 681 to the second longitudinal weld zone 65.

In other words, each lateral portion 684, 685 has a thickness e4, e5 which increases continuously from the central portion 681 to a respective longitudinal weld zone 64, 65.

More precisely, in the example illustrated in FIG. 3, each lateral portion 684, 685 has an edge which delimits the second compartment 12 and which forms a nonzero angle relative to the transverse axis X, on the second side of the transverse axis X where the second compartment 12 is located.

The first lateral portion 684 flares while forming a first nonzero angle θ4 relative to the transverse axis X.

The first angle θ4 is comprised in a range extending from −70° to 0. Preferably, the first angle θ4 is greater than or equal to −50°. Preferably, the first angle θ4 is less than or equal to −20°.

In the example illustrated in FIG. 3, the first angle θ4 is nonzero. More precisely, in this example, the first angle θ4 is equal to −45°.

Likewise, the second lateral portion 685 flares while forming a second nonzero angle θ5 relative to the transverse axis X. The second angle θ5 is symmetrical with the first angle θ4, relative to a longitudinal axis of symmetry.

Thus, the second angle θ5 is comprised in a range extending from 0 to +70°. Preferably, the second angle θ5 is less than or equal to +50°. Preferably, the second angle θ5 is greater than or equal to +20°.

In the example illustrated in FIG. 3, the first angle θ5 is nonzero. More precisely, in this example, the first angle θ5 is equal to +45°.

Due to its thickness e1, less than the thicknesses e4 and e5, the central portion 681 of the separating weld zone 68 constitutes a portion of reduced resistance of the separating weld zone 68.

In addition, the flared shape of the lateral portions 684, 685 of the separating weld zone 68 allows avoiding the presence in the second compartment 12 of nooks in which the second medical substance could accumulate, which would risk degrading the quality of the mixture or not allowing complete emptying of the bag.

Moreover, the first longitudinal weld zone 64 and the second longitudinal weld zone 65 each comprises a first respective portion 641, 651 delimiting the first compartment 11 and a second respective portion 642, 652 delimiting the second compartment 12.

The first portion 641 of the first longitudinal weld zone 64 has a first thickness e6 and the second portion 642 of the first longitudinal weld zone 64 has a second thickness e7, greater than the first thickness e6.

Likewise, the first portion 651 of the second longitudinal weld zone 65 has a first thickness e9 and the second portion 652 of the second longitudinal weld zone 65 has a second thickness e10, greater than the first thickness e9.

In addition, as illustrated in FIG. 3, the first longitudinal weld zone 64 has a junction portion 643 connecting the first portion 641 to the second portion 642 of the first longitudinal weld zone 64. The junction portion 643 flares from the first portion 641 to the second portion 642. The junction portion 643 has a thickness e8 which increases continuously from the first portion 641 to the second portion 642 of the first longitudinal weld zone 64.

In addition, the junction portion 643 connects the first portion 641 to a first end of the separating weld zone 68. The junction portion 643 has an edge 648 which delimits the first compartment 11 and which forms a first angle θ8 relative to the transverse axis X.

The first angle θ8 is comprised in a range extending from 0 to +70°. Preferably, the first angle θ8 is less than or equal to +50°. Preferably, the first angle θ8 is greater than or equal to +20°.

In the example illustrated in FIG. 3, the first angle θ8 is nonzero. More precisely, in this example, the first angle θ8 is equal to +50°.

Likewise, the second longitudinal weld zone 65 has a junction portion 653 connecting the first portion 651 to the second portion 652 of the second longitudinal weld zone 65. The junction portion 653 flares from the first portion 651 to the second portion 652. The junction portion 653 has a thickness e11 which increases continuously from the first portion 651 to the second portion 652 of the second longitudinal weld zone 65.

In addition, the junction portion 653 connects the first portion 651 to a second end of the separating weld zone 68, opposite to the first end. The junction portion 653 has an edge 658 which delimits the first compartment 11 and which forms a second nonzero angle θ11 relative to the transverse axis X.

The second angle θ11 is symmetrical with the first angle θ8, relative to a longitudinal axis of symmetry.

Thus, the second angle θ11 is comprised in a range extending from −70° to 0. Preferably, the second angle θ11 is greater than or equal to −50°. Preferably, the second angle θ11 is less than or equal to −20°.

In the example illustrated in FIG. 3, the second angle θ11 is nonzero. More precisely, in this example, the second angle θ11 is equal to −50°.

In the example illustrated in FIG. 3, each flared junction portion 643, 653 thus has an edge 648, 658 forming respectively a nonzero angle θ8, θ11 relative to the transverse axis X, on the first side of the transverse axis X where the first compartment 11 is located.

The orientation of the edges 648 and 658 of the junction portions 643 and 653 of the first and second longitudinal welds 64 and 65 allows, on the one hand, concentrating the stresses on the separating weld zone 68 when a pressure P is exerted on the first compartment 11, so as to favor a repeatable and controlled rupture of the separating weld zone 68.

On the other hand, this orientation of the edges 648 and 658 of the junction portions 643 and 653 of the first and second longitudinal welds 64 and 65 also allows creating a Venturi effect, once the separating weld zone 68 has been ruptured, which accelerates the speed of the flow of the first medical substance when the first medical substance penetrates into the second compartment 12.

Each longitudinal weld zone 64, 65 has, in its flared junction portion 643, 653, a non-welded spared zone 644, 654, each spared zone 644, 654 being completely surrounded by the weld.

Each longitudinal weld zone 64, 65 also has, in its second portion 642, 652, a non-welded spared zone 645, 655, each spared zone 645, 655 being completely surrounded by the weld.

These spared zones 644, 654, 645, 655 allow avoiding generating folds in the polymer films of the walls during the welding of the first wall 2 and of the second wall 3 together.

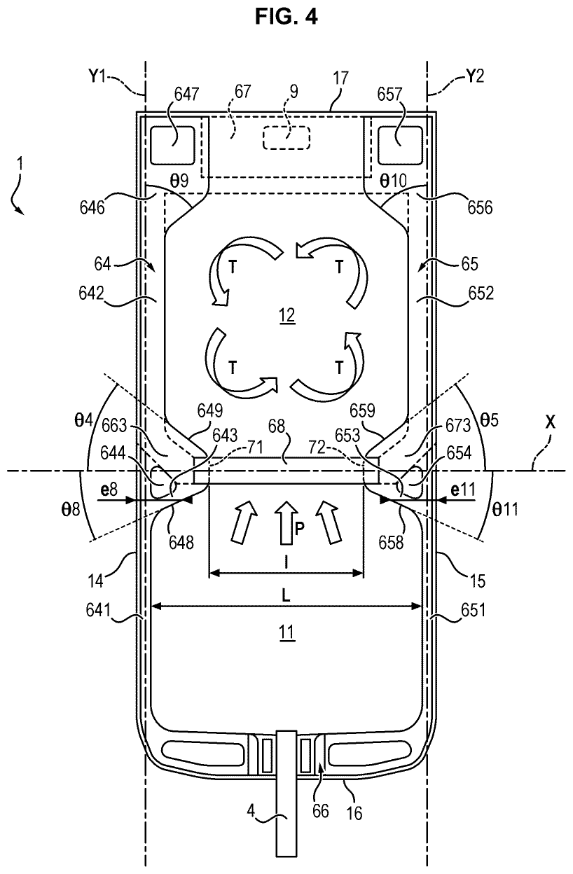

FIG. 4 shows schematically a bag 1 according to a second embodiment.

By way of example, the bag illustrated in FIG. 4 can be dimensioned so that the first compartment 11 is suitable for containing approximately 50 milliliters of the first medical substance in liquid form, while the second compartment 12 is suitable for containing approximately 7 g of the second medical substance in powder form.

As in the first embodiment, the first longitudinal weld zone 64 and the second longitudinal weld zone 65 have been obtained by fusion of the first wall 2 and of the second wall 3 at a first temperature, while the separating weld zone 68 has been obtained by fusion of the first wall and of the second wall 3 at a second temperature, lower than the first temperature.

As illustrated in FIG. 4, in this second embodiment, the separating weld zone 68 extends parallel to the transverse axis X of the bag 1.

The separating weld zone 68 has a rectilinear shape.

In addition, the separating weld zone 68 has a constant thickness e1, along the transverse axis X.

The first junction portion 643 connects the first portion 641 to the second portion 642 of the first longitudinal weld zone 64.

In the example illustrated in FIG. 4, the first longitudinal weld 64 comprises a third junction portion 663.

The first junction portion 643 connects the first portion 641 to the third junction portion 663. The third junction portion 663 connects the first junction portion 643 to the second portion 642 of the first longitudinal weld zone 64.

The first junction portion 643 of the first longitudinal weld 64 flares from the first portion 641 to the separating weld zone 68.

The third junction portion 663 narrows from the separating weld zone 68 to the second portion 642 of the first longitudinal weld zone 64.

In other words, the junction portion 643 has a thickness e8 which increases continuously from the first portion 641 to the separating weld zone 68 and the junction portion 663 has a thickness e8 which decreases continuously from the separating weld zone 68 to the second portion 642 of the first longitudinal weld zone 64.

Likewise, the second longitudinal weld 65 comprises a fourth junction portion 673

The second junction portion 653 connects the first portion 651 to the fourth junction portion 673. The fourth junction portion 673 connects the second junction portion 653 to the second portion 652 of the second longitudinal weld zone 65.

The second junction portion 653 of the second longitudinal weld 65 flares from the first portion 651 to the separating weld zone 68 of the second longitudinal weld zone 65.

The fourth junction portion 673 narrows from the separating weld zone 68 to the second portion 652 of the second longitudinal weld zone 65.

In other words, the junction portion 653 has a thickness e11 which increases continuously from the first portion 651 to the separating weld zone 68 and the junction portion 673 has a thickness which decreases continuously from the separating weld zone 68 to the second portion 652.

The separating weld zone 68 extends from the first longitudinal weld zone 64 to the second longitudinal weld zone 65, so as to form a first junction 71 between the separating weld zone 68 and the first longitudinal weld zone 64, and a second junction 72 between the separating weld zone 68 and the second longitudinal weld zone 65.

More precisely, in the example illustrated in FIG. 4, the separating weld zone 68 extends from the junction portion 643 of the first longitudinal weld 64 to the junction portion 653 of the second longitudinal weld 65.

The separating weld zone 68 has a dimension I measured between the first junction 71 and the second junction 72, parallel to the transverse axis X.

The first compartment 11 has a dimension L measured between the first longitudinal weld 64 and the second longitudinal weld 65, parallel to the transverse axis X. The dimension L corresponds to the maximum spacing between the first longitudinal weld 64 and the second longitudinal weld 65 measured along an axis passing through the first compartment 11, parallel to the transverse axis X.

The ratio I/L is comprised in a range extending from ⅓ to ¾, preferably in a range extending from ⅓ to ⅔.

More precisely, in the example illustrated in FIG. 4, the ratio I/L is equal to 0.57.

The junction portion 643 has an edge 648 which delimits the first compartment 11 and which forms a first angle θ8 relative to the transverse axis X.

The first angle θ8 is comprised in a range extending from 0 à +70°. Preferably, the first angle θ8 is less than or equal to +50°. Preferably, the first angle θ8 is greater than or equal to +20°.

In the example illustrated in FIG. 4, the first angle θ8 is nonzero. More precisely, in this example, the first angle θ8 is equal to +20°.

Likewise, the junction portion 653 connects the first portion 651 to a second end of the separating weld zone 68, opposite to the first end. The junction portion 653 has an edge 658 which delimits the first compartment 11 and which forms a second nonzero angle θ11 relative to the transverse axis X.

The second angle θ11 is symmetrical with the first angle θ8, relative to a longitudinal axis of symmetry.

Thus the second angle θ11 is comprised in a range extending from −70° to 0. Preferably, the second angle θ11 is greater than or equal to −50°. Preferably, the second angle θ11 is less than or equal to −20°.

In the example illustrated in FIG. 4, the second angle θ11 is nonzero. More precisely, in this example, the second angle θ11 is equal to −20°.

Thus, each junction portion 643, 653 has an edge 648, 658 forming respectively a nonzero angle θ8, θ11 relative to the transverse axis X, on the first side of the transverse axis X where the first compartment 11 is located.

Moreover, the junction portion 643 has another edge 649 which delimits the second compartment 12 and which forms a third angle θ4 relative to the transverse axis X.

The third angle θ4 is comprised in a range extending from −70° to 0. Preferably, the third angle θ4 is greater than or equal to −50°. Preferably, the third angle θ4 is less than or equal to −20°.

In the example illustrated in FIG. 4, the third angle θ4 is non-zero. More precisely, in this example, the third angle θ4 is equal to −40°.

Likewise, the junction portion 653 has another edge 659 which delimits the second compartment 12 and which forms a fourth nonzero angle θ5 relative to the transverse axis X.

The fourth angle θ5 is symmetrical with the third angle θ4, relative to a longitudinal axis of symmetry.

Thus, the fourth angle θ4 is comprised in a range extending from 0 to +70°. Preferably, the fourth angle θ4 is less than or equal to +50°. Preferably, the fourth angle is greater than or equal to +20°.

In the example illustrated in FIG. 4, the fourth angle θ5 is nonzero. More precisely, in this example, the fourth angle θ5 is equal to +40°.

Each junction portion 643, 653 thus has an edge 649, 659 forming respectively a nonzero angle θ4, θ5 relative to the transverse axis X, on the second side of the transverse axis X where the second compartment 12 is located.

Moreover, each longitudinal weld zone 64, 65 also comprises a junction portion 646, 656 which flares from the portion 642, 652 to the second transverse weld 67.

The junction portion 646 of the first longitudinal weld zone 64 has an edge which forms a fifth nonzero angle θ9 relative to a first longitudinal axis Y1 of the bag 1. The first longitudinal axis Y1 extends parallel to the first edge 14 while passing through the first longitudinal weld zone 64. The junction portion 646 of the first longitudinal weld zone 64 flares toward one side of the first longitudinal axis Y1 where the second compartment 12 is located.

The fifth angle θ9 is comprised in a range extending from −70° to 0. Preferably, the fifth angle θ9 is greater than or equal to −50°. Preferably, the fifth angle θ9 is less than or equal to −20°.

In the example illustrated in FIG. 4, the fifth angle θ9 is nonzero. More precisely, in this example, the fifth angle θ9 is equal to −50°.

Likewise, the junction portion 656 of the second longitudinal weld zone 65 has an edge which forms a sixth nonzero angle θ10 relative to a second longitudinal axis Y2 of the bag 1. The second longitudinal axis Y2 extends parallel to the second edge 15 while passing through the second longitudinal weld zone 65. The junction portion 656 of the second longitudinal weld zone 65 flares toward one side of the second longitudinal axis Y2 where the second compartment 12 is located.

The second angle θ10 is symmetrical with the first angle θ9, relative to a longitudinal axis of symmetry.

The sixth angle θ10 is comprised in a range extending from 0 to +70°. Preferably, the sixth angle θ10 is less than or equal to +50°. Preferably, the sixth angle θ10 is greater than or equal to +20°.

In the example illustrated in FIG. 4, the sixth angle θ10 is nonzero. More precisely, in this example, the sixth angle θ10 is equal to +50°.

The flared shape of the junction portions 643, 653, 646, 656 of the longitudinal weld zones 64, 65 guides the flow of the first medical substance into the interior of the second compartment 12, so as to generate a swirl T inside the second compartment 12 (as illustrated by the arrows). The swirl T increases the effectiveness of the mixing between the first substance and the second substance in the second compartment 12. In fact, the swirl favors the circulation of the first medical substance in the entire volume of the second compartment 12.

In addition, each longitudinal weld zone 64, 65 has, in its junction portion 643, 653 a non-welded spared zone 644, 654, each spared zone 644, 654 being completely surrounded by the weld.

Moreover, each longitudinal weld zone 64, 65 has, in its junction portion 646, 656, a non-welded spared zone 647, 657, each spared zone 647, 657 being completely surrounded by the weld.

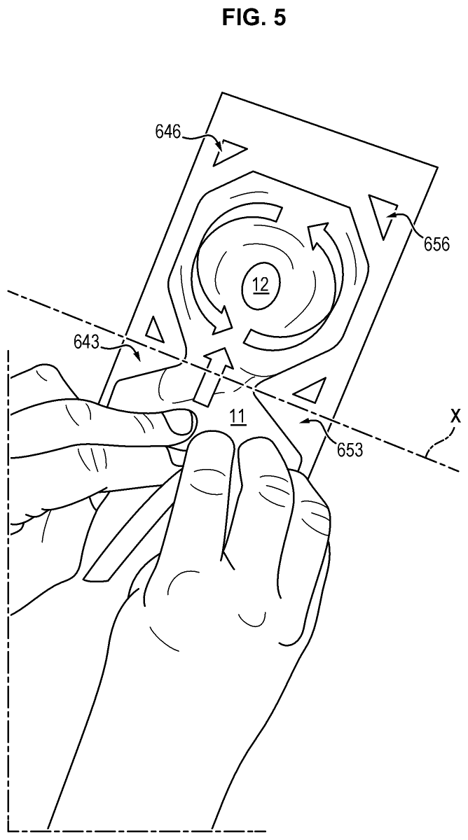

As illustrated in FIG. 5, to prepare a medicinal solution using the bag 1, the first compartment 11 can be pressed manually so as to generate an increase in pressure in the first compartment 11 until it causes a rupture of the separating weld zone 68.

To this end, the bag 1 can be folded along the transverse axis X, then pressed in the folded position.

The rupture of the separating weld zone 68 has the effect of putting the first compartment 11 into communication with the second compartment 12.

The bag 1 can then be unfolded.

By continuing to apply pressure to the first compartment 11, the pressure exerted on the first compartment 11 causes penetration of the first medical substance into the second compartment 12, where the first medical substance mixes with the second medical substance.

The shape of the junction portions 643 and 653 of the first and second longitudinal welds 64 and 65 allows, on the one hand, concentrating the stresses on the separating weld zone 68 when a pressure P is exerted on the first compartment 11 (as illustrated by the arrows in FIG. 4, in the first compartment 11), so as to favor a repeatable and controlled rupture of the separating weld zone 68.

On the other hand, this shape of the junction portions 643 and 653 of the first and second longitudinal welds 64 and 65 also allows creating a Venturi effect, once the separating weld zone 68 has been ruptured, which accelerates the speed of the flow of the first medical substance when the first medical substance penetrates into the second compartment 12.

In addition, the flared shape of the portions 643, 653, 646 and 656 guides the flow of the first medical substance inside the second compartment 12, so as to form a swirl inside the second compartment 12 (as illustrated by the arrows in FIGS. 3 and 4, in the second compartment 12). The swirl phenomenon increases the effectiveness of the mixing between the first substance and the second substance. In fact, the swirl favors the circulation of the first medical substance in the entire volume of the second compartment 12.

Finally, the edges 649 and 659 create a funnel shape which facilitates the flow of the medical substance (consisting of the mixture of the first medical substance and the second medical substance) from the second compartment 12 toward the first compartment 11, during the administration of the medical substance. In other words, the inclined edges 649 and 659 avoid retention of a part of the medical substance in the second compartment 12 during the emptying of the bag.

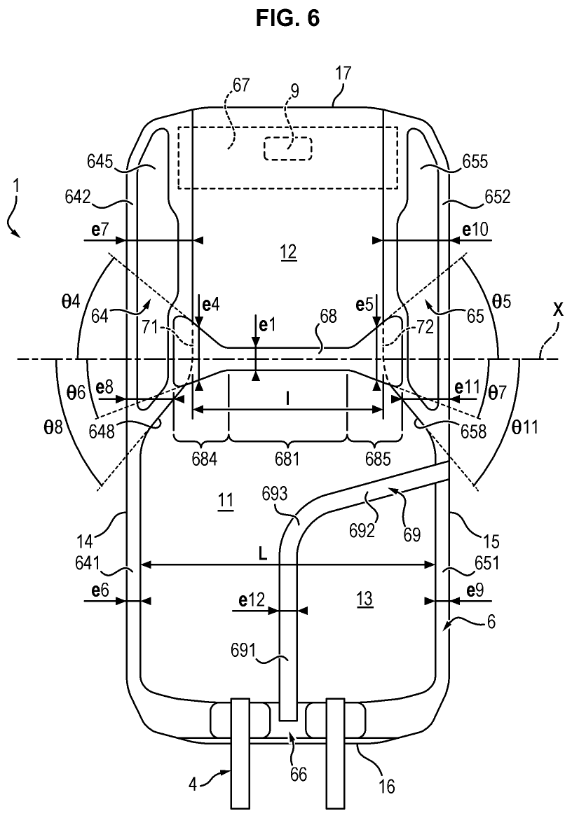

FIG. 6 shows schematically a bag 1 according to a third possible embodiment, in which the bag comprises three compartments.

In this third embodiment, the first wall 2 and the second wall 3 are assembled together by welding at a plurality of weld zones 6. The weld zones 6 delimit a first compartment 11, a second compartment 12, and a third compartment 13.

The first compartment 11 is intended to contain a first medical substance, the second compartment 12 is intended to contain a second medical substance, and the third compartment 13 is intended to contain a third medical substance.

The first medical substance is a liquid substance, the second medical substance is a powder or a lyophilisate, and the third substance is a liquid substance.

By way of example, the bag illustrated in FIG. 6 can be dimensioned so that the first compartment 11 is suitable for containing approximately 80 milliliters of the first medical substance in liquid form, the second compartment 12 is suitable for containing approximately 5 grams of the second medical substance in powder form, and the third compartment 13 is suitable for containing approximately 20 milliliters of the third medical substance in liquid form.

The second compartment 12 is separated from the first compartment 11 by a first separating weld zone 68. That is to say that the first separating weld zone 68 extends between the first compartment 11 and the second compartment 12. The first separating weld zone 68 prevents penetration of the first medical substance contained in the first compartment 11 into the second compartment 12, and prevents penetration of the second medical substance contained in the second compartment 12 into the first compartment 11.

The third compartment 13 is separated from the first compartment 11 by a second separating weld zone 69. That is to say that the second separating weld zone 69 extends between the first compartment 11 and the third compartment 13. The second separating weld zone 69 prevents penetration of the first medical substance contained in the first compartment 11 into the third compartment 13, and prevents penetration of the third medical substance contained in the third compartment 13 into the first compartment 11.

The first separating weld zone 68 extends from the first longitudinal weld zone 64 to the second longitudinal weld zone 65. The first separating weld zone 68 extends in a transverse direction, along a transverse axis X of the bag 1. The transverse axis X extends between the first compartment 11 and the second compartment 12. The first compartment 11 is located on a first side of the transverse axis X, and the second compartment 12 is located on a second side of the transverse axis X, opposite to the first side.

The first separating weld zone 68 extends from the first longitudinal weld zone 64 to the second longitudinal weld zone 65, so as to form a first junction 71 between the separating weld zone 68 and the first longitudinal weld zone 64, and a second junction 72 between the separating weld zone 68 and the second longitudinal weld zone 65.

The separating weld zone 68 has a dimension I measured between the first junction 71 and the second junction 72, parallel to the transverse axis X.

Moreover, the first compartment 11 has a dimension L measured between the first longitudinal weld 64 and the second longitudinal weld 65, parallel to the transverse axis X. The dimension L corresponds to the maximum spacing between the first longitudinal weld 64 and the second longitudinal weld 65 measured along a transverse axis X passing through the first compartment 11.

The ratio I/L is comprised in a range extending from ⅓ to ¾, preferably in a range extending from ⅓ to ⅔.

More precisely, in the example illustrated in FIG. 6, the ratio I/L is equal to 0.65.

In the example illustrated in FIG. 6, the first separating weld zone 68 comprises a central portion 681 and two lateral portions 684 and 685 arranged on either side of the central portion 681. Each lateral portion 684, 685 extends from the central portion 681, to a respective longitudinal weld zone 64, 65.

In the example illustrated in FIG. 6, the central portion 681 of the first separating weld zone 68 is rectilinear. The central portion 681 extends parallel to the transverse axis X of the bag 1.

In the example illustrated in FIG. 6, the central portion 681 of the separating weld zone 68 has a constant thickness e1.

In addition, the thickness e1 of the central portion 681 of the separating weld zone 68 is less than a thickness e4, e5 of each of the lateral portions 684, 685 of the separating weld zone 68.

Each lateral portion 684, 685 of the first separating weld zone 68 flares while forming a nonzero angle relative to the transverse axis X, on each side of the transverse axis.

The first lateral portion 684 of the first separating weld zone 68 flares from the central portion 681 to the first longitudinal weld zone 64.

Likewise, the second lateral portion 685 of the first separating weld zone 68 flares from the central portion 681 to the second longitudinal weld zone 65.

In other words, each lateral portion 684, 685 has a thickness e4, e5 which increases continuously from the central portion 681 to a respective longitudinal weld zone 64, 65.

In the example illustrated in FIG. 6, each lateral portion 684, 685 has an edge which forms a nonzero angle θ6 relative to the transverse axis X, on the first side of the transverse axis where the first compartment 11 is located, and another edge which forms a nonzero angle θ7 relative to the transverse axis X, on the second side of the transverse axis X where the second compartment 12 is located.

More precisely, the first lateral section 684 of the separating weld zone 68 flares while forming a first nonzero angle θ6 on the first side of the transverse axis X where the first compartment 11 is located.

The second lateral portion 685 of the separating weld zone 68 flares while forming a second nonzero angle θ7 on the first side of the transverse axis X where the first compartment 11 is located.

The first lateral portion 684 of the separating weld zone 68 flares while forming a third nonzero angle θ4 on the second side of the transverse axis X where the second compartment 12 is located.

The second lateral portion 685 of the separating weld zone 68 flares while forming a fourth nonzero angle θ5 on the second side of the transverse axis X where the second compartment 12 is located.

In addition, in the embodiment illustrated in FIG. 6, the first nonzero angle θ6 is symmetrical with the third nonzero angle θ7, relative to a longitudinal axis of symmetry. The second nonzero angle θ4 is symmetrical with the fourth nonzero angle θ5, relative to a longitudinal axis of symmetry.

Moreover, the first longitudinal weld zone 64 and the second longitudinal weld zone 65 each comprises a first portion 641, 651 delimiting the first compartment 11 and a second portion 642, 652 delimiting the second compartment 12.

The first portion 641 of the first longitudinal weld zone 64 has a first thickness e6 and the second portion 642 of the first longitudinal weld zone 64 has a second thickness e7, greater than the first thickness e6.

Likewise, the first portion 651 of the second longitudinal weld zone 65 has a first thickness e9 and the second portion 652 of the second longitudinal weld zone 65 has a second thickness e10, greater than the first thickness e9.

In addition, as illustrated in FIG. 6, the first longitudinal weld zone 64 has a junction portion 643 connecting the first portion 641 to the second portion 642 of the first longitudinal weld zone 64. The junction portion 643 flares from the first portion 641 to the second portion 642. The junction portion 643 has a thickness e8 which increases continuously from the first portion 641 to the second portion 642 of the first longitudinal weld zone 64.

In addition, the junction portion 643 connects the first portion 641 to a first end of the separating weld zone 68. The junction portion 643 has an edge 648 which delimits the first compartment 11 and which forms a first angle θ8 relative to the transverse axis X.

The first angle θ8 is comprised in a range extending from 0 to +70°. Preferably, the first angle θ8 is less than or equal to +50°. Preferably, the first angle θ8 is greater than or equal to +20°.

In the example illustrated in FIG. 6, the first angle θ8 is nonzero. More precisely, in this example, the first angle θ8 is equal to +50°.

Likewise, the second longitudinal weld zone 65 has a junction portion 653 connecting the first portion 651 to the second portion 652 of the second longitudinal weld zone 65. The junction portion 653 flares from the first portion 651 to the second portion 652. The junction portion 653 has a thickness e11 which increases continuously from the first portion 651 to the second portion 652 of the second longitudinal weld zone 65.

In addition, the junction portion 653 connects the first portion 651 to a second end of the separating weld zone 68, opposite to the first end. The junction portion 653 has an edge 658 which delimits the first compartment 11 and which forms a second nonzero angle θ11 relative to the transverse axis X.

The second angle θ11 is symmetrical with the first angle θ8, relative to a longitudinal axis of symmetry.

Thus, the second angle θ11 is comprised in a range extending from −70 ° to 0. Preferably, the second angle θ11 is greater than or equal to −50°. Preferably, the second angle θ11 is less than or equal to −20°.

In the example illustrated in FIG. 3, the second angle θ11 is nonzero. More precisely, in this example, the second angle θ11 is equal to −50°.

In the example illustrated in FIG. 6, each flared junction portion 643, 653 has and edge 648, 658 forming respectively a nonzero angle θ8, θ11 relative to the transverse axis X, on the first side of the transverse axis X where the first compartment 11 is located.

Moreover, each longitudinal weld zone 64, 65 has, in its flared junction portion 643, 653, a non-welded spared zone 644, 654, each spared zone 644, 654 being completely surrounded by the weld.

Each longitudinal weld zone 64, 65 also has, in its second portion 642, 652, a non-welded spared zone 645, 655, each spared zone 645, 655 being completely surrounded by the weld.

The spared zones 644, 654, 645, 655 allow avoiding generating folds in the polymer films of the walls during the welding of the first wall 2 and of the second wall 3 together.

The second separating weld zone 69 extends from the first transverse weld zone 66 to the second longitudinal weld zone 65.

The second separating weld zone 69 has a substantially constant thickness e12 from the first transverse weld zone 66 to the second longitudinal weld zone 65.

The second separating weld zone 69 comprises a first portion 691 extending from the first transverse weld zone 66, a second portion 692 extending to the second longitudinal weld zone 65 and a third portion 693 connecting the first portion 691 and the second portion 692 together. The first portion 691 has a substantially rectilinear shape. The second portion 692 also has a substantially rectilinear shape. The third portion 693 has a curved shape. More precisely, the third portion 693 has a curvature having a convex side and a concave side, the first compartment 11 being located on the convex side of the curvature and the third compartment 13 being located on the concave side of the curvature.

The second separating weld zone 69 is also a peelable weld zone.

The bag 1 also comprises a first filling tube 4 and a second filling tube 10.

The first filling tube 4 is arranged between the first wall 2 and the second wall 3 through the first transverse weld zone 65, so as to allow filling of the first compartment 11 with the first medical substance via the first filling tube 4.

The second filling tube 10 is arranged between the first wall 2 and the second wall 3 through the first transverse weld zone 65, so as to allow filling of the third compartment 13 with the third medical substance via the second filling tube 10.

Once the first compartment 11 has been filled with the first medical substance, the first filling tube 4 can be permanently closed, by a stopper or a weld for example.

Once the third compartment 13 has been filled with the third medical substance, the second filling tube 10 can be blocked by a connector.

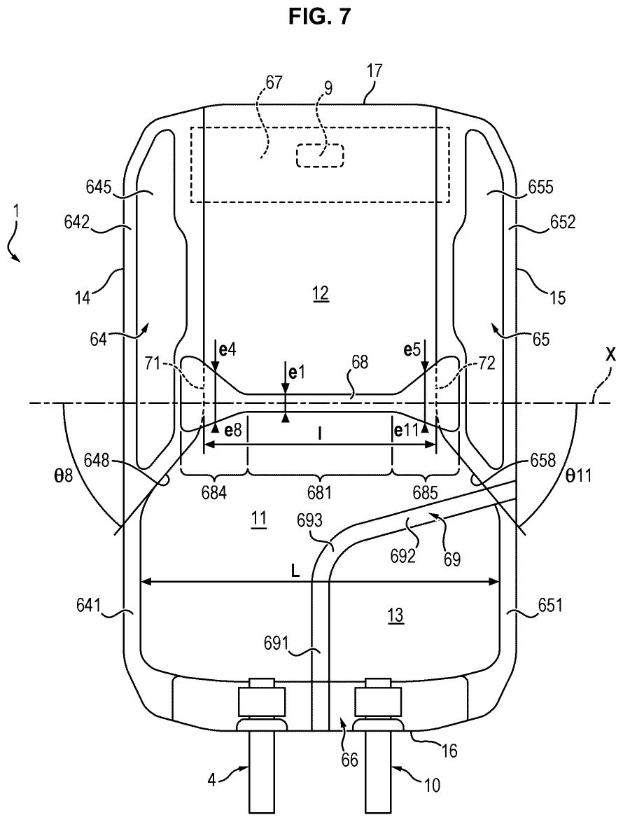

FIG. 7 shows schematically a bag 1 according to a fourth possible embodiment.

By way of example, the bag illustrated in FIG. 7 can be dimensioned so that the first compartment 11 is suitable for containing approximately 40 milliliters of the first medical substance in liquid form, the second compartment 12 is suitable for containing approximately 100 grams of the second medical substance in powder form, and the third compartment 13 is suitable for containing approximately 10 milliliters of the third medical substance in liquid form.

The intravenous perfusion bag 1 illustrated in FIG. 7 has features identical to those of the bag illustrated in FIG. 6, except for the compartments 11, 12 and 13 having different contents.

The first separating weld zone 68 extends from the first longitudinal weld zone 64 to the second longitudinal weld zone 65, so as to form a first junction 71 between the separating weld zone 68 and the first longitudinal weld zone 64, and a second junction 72 between the separating weld zone 68 and the second longitudinal weld zone 65.

The separating weld zone 68 has a dimension I measured between the first junction 71 and the second junction 72, parallel to the transverse axis X.

Moreover, the dimension L is measured between the first permanent weld 64 and the second permanent weld 65 along an axis parallel to the transverse axis X and passing through the first compartment 11.

This dimension L corresponds to the maximum spacing between the first longitudinal weld 64 and the second longitudinal weld 65 measured along a transverse axis X passing through the first compartment 11.

In the example illustrated in FIG. 7, axis parallel to the transverse axis X passes both through the first compartment 11 and through the third compartment 13.

The ratio I/L is comprised in a range extending from ⅓ to ¾.

The ratio I/L is comprised in a range extending from ⅓ to ¾, preferably in a range extending from ⅓ to ⅔.

More precisely, in the example illustrated in FIG. 7, the ratio I/L is equal to 0.65.

To prepare a medicinal solution using the bag 1, the third compartment 13 can be manually pressed so as to generate an increase in the pressure in the third compartment 13 until it causes a rupture of the third separating weld zone 69.

The rupture of the second separating weld zone 69 has the effect of putting the third compartment 13 into communication with the first compartment 11.

In other words, once the second separating weld zone 69 is ruptured, the two compartments 11 and 13 then form a same single compartment 11+13 containing a mixture of the first medical substance and of the third medical substance.

Thus, in the continuation of the preparation method, the bag 1 can be used like a bag with two compartments.

According to a second step, the compartment containing the mixture can be pressed manually so as to generate an increase in the pressure in the compartment 11+13 until it causes a rupture of the separating weld zone 68.

To this end, the bag 1 can be folded along the transverse axis X, the pressed in the folded position.

The rupture of the first separating weld zone 68 has the effect of putting the compartment 11+13 into communication with the second compartment 12.

The bag 1 can then be unfolded.

By continuing to apply pressure on the compartment 11+13, the pressure exerted on the compartment 11+13 causes penetration of the first medical substance into the second compartment 12, where the mixture consisting of the first medical substance and of the second medical substance mixes with the third medical substance.

### Example

Several bags 1 were tested with the parameters mentioned in Table 1.

Each bag tested comprises a first compartment 11 containing approximately 100 milliliters of a first liquid substance and a second compartment containing approximately 5 grams of a second solid substance in powder form.

The first compartment 11 was pressed so as to obtain an increase in pressure in the first substance contained in the first compartment 11 of approximately 0.6 bars.

The presence of “dead zones” signifies that there subsists powder in the second compartment 12 that is not mixed with liquid. This signifies that the mixing is not sufficiently effective.

The extent of the rupture of the peelable weld was observed in order to determine whether this rupture was sufficient to allow sufficient liquid flow to pass from the first compartment 11 to the second compartment 12.

The head loss of the liquid flow which penetrates into the second compartment 12 was estimated. Too great a head loss prevents the liquid from penetrating into the second compartment with a sufficient flow rate to guarantee good effectiveness of the mixing between the liquid and the powder.

TABLE 1

| | | | | | | Rupture of | |
|---|---|---|---|---|---|---|---|
| | L | I | | θ8 | Dead | peelable | |
| Bag | (mm) | (mm) | I/L | (=−θ11) | zones | weld | Head loss |
| 1 | 100 | 33 | 0.33 | 0° | YES | Complete | Very high |
| 2 | 100 | 33 | 0.33 | 85° | NO | Incomplete | Negligible |
| 3 | 100 | 50 | 0.50 | 0° | YES | Complete | High |
| 4 | 100 | 50 | 0.50 | 45° | NO | Complete | Medium |
| 5 | 100 | 50 | 0.50 | 70° | NO | Incomplete | Low |
| 6 | 100 | 50 | 0.50 | 85° | NO | Incomplete | Negligible |

The distribution of stresses in the peelable weld zone is sufficiently homogenous when the ratio I/L is less than or equal to ¾. This homogenous distribution allows obtaining a complete rupture of the peelable weld zone.

Conversely, when the ratio I/L becomes greater than ¾, the stresses exerted on the peelable weld zone are no longer homogeneously distributed along the peelable weld zone. In this case, the rupture of the peelable weld zone is incomplete, which does not allow accurately controlling the location of the rupture and causes a great head loss in the liquid flow which penetrates into the second compartment 12.

On the other hand, a ratio I/L less than ⅓ has the effect that the peelable weld zone becomes difficult to rupture. In this case, the extent of the rupture of the peelable weld zone can also be incomplete which does not allow generating a flow rate of the first medical substance which penetrates into the second compartment sufficient to guarantee complete and homogenous mixing with the second medical substance.

Moreover, the presence of nonzero angles θ8 and θ11 allows guiding the flow of liquid and thus reducing the head loss generated by the passage of the liquid into the third compartment through the opening created in the peelable weld zone.

However, too high a value of the angle θ8 (greater than +70°) has the effect of cancelling the benefits procured by the ratio I/L less than or equal to ¾.

1. A bag intended to contain medical substances for intravenous injection, comprising:
a first wall, and
a second wall,
the first wall and the second wall being assembled together by weld zones, the weld zones delimiting at least one first compartment intended to contain a first medical substance and at least one second compartment intended to contain a second medical substance,
wherein the weld zones include:
a first permanent weld zone extending along a first longitudinal edge of the bag,
a second permanent weld zone extending along a second longitudinal edge of the bag, opposite to the first longitudinal edge, and
a third peelable weld zone separating the first compartment from the second compartment,
wherein the third peelable weld zone extends from the first permanent weld zone to the second permanent weld zone, so as to form a first junction between the third peelable weld zone and the first permanent weld zone, and a second junction between the third peelable weld zone and the second permanent weld zone,
and wherein a ratio I/L between a dimension I of the third peelable weld zone measured between the first junction and the second junction along a transverse axis, and a dimension L measured between the first permanent weld and the second permanent weld along an axis parallel to the transverse axis and passing through the first compartment, is comprised in a range extending from ⅓ to ¾.

2. The bag according to claim 1, wherein the ratio I/L is comprised in a range extending from 1⅓ to ⅔.

3. The bag according to claim 1, wherein the first permanent weld zone comprises a first longitudinal portion extending parallel to the first longitudinal edge of the bag and a first flaring portion extending from the first longitudinal portion to the first junction, the first flared portion delimiting the first compartment by forming a first angle comprised in a range extending from 0° to +70° with a transverse axis extending perpendicular to the longitudinal edges, and the second permanent weld zone comprises a second longitudinal portionextending parallel to the second longitudinal edge of the bag and a second flaring portion extending from the second longitudinal portion to the second junction, the second flaring portion delimiting the first compartment by forming a second angle comprised in a range extending from −70° to 0 with the transverse axis.

4. The bag according to claim 3, wherein the first angle is comprised in a range extending from 0° to +50° relative to the transverse axis, and the second angle is comprised in a range extending from −50° to 0° with the transverse axis.

5. The bag according to claim 3, wherein the first angle is comprised in a range extending from +20° to +50° relative to the transverse axis, and the second angle is comprised in a range extending from −50° to −20° with the transverse axis.

6. The bag according to claim , wherein the first permanent weld zone comprises a third longitudinal portion extending parallel to the first longitudinal edge the bag and a third flaring portion extending from the third longitudinal portion to the first junction, the third flaring portion delimiting the second compartment by forming a third angle comprised in a range extending from −70° to 0° with a transverse axis extending perpendicular to the longitudinal edges, and the second permanent weld zone comprises a fourth longitudinal portion extending parallel to the second longitudinal edge of the bag and a fourth flaring portion extending from the fourth longitudinal portion to the second junction, the fourth flaring portion delimiting the second compartment by forming a fourth angle comprised in a range extending from 0° to +70° with the transverse axis.

7. The bag according to claim 6, wherein the third angle is comprised in a range extending from −50° to 0° relative to the transverse axis, and the fourth angle is comprised in a range extending from 0° to +50° with the transverse axis.

8. The bag according to claim 6, wherein the third angle is comprised in a range extending from −50° to −20° relative to the transverse axis, and the fourth angle is comprised in a range extending from +20° to +50° with the transverse axis.

9. The bag according to claim 1 , wherein:
the first permanent weld zone and the second permanent weld zone have been obtained by fusion of the first wall and of the second wall at a first temperature, and
the third peelable weld zone has been obtained by fusion of the first wall and of the second wall at a second temperature, lower than the first temperature, so that when the first medical substance is received in the first compartment and a pressure is exerted on the first compartment, the pressure exerted on the first compartment causes a rupture of the third peelable weld zone, thus allowing penetration of the first medical substance into the second compartment.

10. The bag according to claim 1, comprising the first medical substance contained in the first compartment.

11. The bag according to claim 10, wherein the first medical substance is a liquid substance.

12. The bag according to claim 1, comprising the second medical substance contained in the second compartment .

13. The bag according to claim 12, wherein the second medical substance is a powder or a lyophilisate.

14. A method for preparing a medicinal solution using a bag according to claim 1, wherein the first compartment of the bag contains a first medical substance and the second compartment of the bag contains a second medical substance, the method comprising a step of:
pressing the first compartment so as to cause a rupture of the third peelable weld zone, thus allowing a penetration of the first medical substance into the second compartment.

15. A method for manufacturing a bag, comprising steps of:
welding together a first wall and a second wall at weld zones, the weld zones delimiting at least one first compartment intended to receive a first medical substance and at least one second compartment intended to receive a second medical substance, and
wherein the weld zones include:
a first permanent weld zone extending along a first longitudinal edge of the bag,
a second permanent weld zone extending along a second longitudinal edge of the bag, opposite to the first longitudinal edge, and
a third peelable weld zone separating the first compartment from the second compartment,
wherein the third peelable weld zone extends from the first permanent weld zone to the second permanent weld zone, so as to form a first junction between the third peelable weld zone and the first permanent weld zone and a second junction between the third peelable weld zone and the second permanent weld zone,
and wherein a ratio I/L between a dimension I of the third peelable weld zone measured between the first junction and the second junction, and a dimension L of the first compartment measured between the first permanent weld and the second permanent weld, is comprised in a range extending from ⅓ to ¾.

16. The method according to claim 15, wherein the steps of welding together the first wall and the second wall comprise:
welding the first wall and the second wall at the first permanent weld zone and at the second permanent weld zone, by fusion of the first wall and of the second wall at a first temperature, and
welding together the first wall and the second wall at the third peelable weld zone, by fusion of the first wall and of the second wall at a second temperature, lower than the first temperature.
